(19) United States
(12) Patent Application Publication
(10) Pub. No.: US 2003/0114327 A1
(43) Pub. Date: Jun. 19, 2003

(54) Aqueous alkaline paint stripper

(76) Inventors: Hans-Joergen Rehm, Hilden (DE); Brigitte Spei, Duesseldorf (DE)

Correspondence Address: HENKEL CORPORATION, 2500 RENAISSANCE BLVD, STE 200, GULPH MILLS, PA, 19406, US

(21) Appl. No.: 10/319,284

(22) Filed: Dec. 13, 2002

(30) Foreign Application Priority Data
Dec. 15, 2001 (DE) DE 10161844.1

(51) Int. Cl. C11D 1/00; C09D 9/00

(52) U.S. Cl. 510/201; 510/505; 510/506

(57) ABSTRACT

Disclosed herein are aqueous alkaline paint stripper compositions which contain one or more organic alcohols, a source of alkali, and at least one ethoxylation and/or propoxylation product of an alcohol bearing an aromatic cyclic substituent with 2 to 15 moles of ethylene oxide and/or propylene oxide. The organic alcohols preferably comprise a mixture of b1) di- or triethylene glycol with b2) one or more alcohols bearing a saturated, unsaturated or aromatic homo- or heterocyclic cyclic substituent, in a weight ratio of b1) to b2) of 1:0.1 to 1:1. The compositions are particularly effective for removing paint or lacquer from metal surfaces with a reduction in processing times and in adverse environmental consequences.

### BACKGROUND OF THE INVENTION

1. Field of the Invention

The invention relates to an agent and a process for stripping lacquer from metal surfaces, particularly from metal surfaces made of steel. A particularly good paint stripping effect is achieved due to the fact that the paint stripper contains, as an additional component, alkoxylation products of an alcohol with aromatic cyclic substituents.

2. Prior Processes and Compositions

In production processes in which metallic components are coated, poorly coated parts and the mechanical devices used during the coating process, such as suspension tackle, regularly have to be stripped of lacquer. Aqueous alkaline paint strippers, for example, are available for this purpose. Apart from water, these usually contain caustic alkali and, as active substances, various glycols, benzyl alcohol, furfuryl alcohol and/or phenoxy ethanol. In addition, they may contain additives such as solubilisers, thickeners, wetting agents and corrosion inhibitors.

There is a constant need on the market for products which can also be used for new, largely chemical-resistant lacquer systems which permit shorter paint stripping times and comply with present-day environmental standards. This includes the effort to reduce the concentration of active substance required. The object of the present invention is to improve in this respect aqueous based products available hitherto.

The invention is based on the realisation that certain alkoxylation products of alcohols with aromatic cyclic substituents markedly improve the paint stripping effect of conventional paint strippers.

### SUMMARY OF THE INVENTION

In a first aspect, the invention relates to an aqueous alkaline paint stripper which contains water, one or more organic alcohols and sources of alkali, characterised in that it additionally contains at least one ethoxylation and/or propoxylation product of an alcohol bearing an aromatic, cyclic substituent, with 2 to 15 moles of ethylene oxide and/or propylene oxide.

### DETAILED DESCRIPTION OF THE INVENTION

Suitable sources of alkali for the purposes of the present invention include, preferably, caustic alkalis such as sodium or potassium hydroxide. For solubility reasons, the use of potassium hydroxide is preferred.

A more particular paint stripper for the purposes of the present invention is characterised in that it contains

a) 40 wt. % to 80 wt. % of water,

b) 10 wt. % to 40 wt. % of organic alcohol,

c) 5 wt. % to 25 wt. % of source of alkali,

d) 1 wt. % to 25 wt. % of ethoxylation and/or propoxylation product of an alcohol bearing an aromatic cyclic substituent, with 2 to 15 moles of ethylene oxide and/or propylene oxide and if desired

e) further active or auxiliary substances, the quantity proportions adding up to 100 wt. %.

The organic alcohols b) may generally be selected from glycols or polyglycols which may be etherified on one side, for example, with alcohols having 1 to 5 carbon atoms. Di- or triethylene glycol or monoethers thereof are particularly suitable. Together with or instead of these, alcohols having a saturated, unsaturated or aromatic homo- or heterocyclic cyclic substituent may be used. The use of a mixture of glycol compounds and the last named alcohols with cyclic substituents is preferred. A preferred paint stripper for the purposes of the present invention is characterised in that the organic alcohol b)is a mixture of b1) di- or triethylene glycol with b2) one or more alcohols having a saturated, unsaturated or aromatic homo- or heterocyclic cyclic substituent, in a weight ratio b1) to b2) of 1:0.1 to 1:1. Suitable alcohols of the group b2)include in particular benzyl alcohol, furfuryl alcohol and phenoxy ethanol.

The ethoxylation and/or propoxylation product of an alcohol bearing an aromatic cyclic substituent with 2 to 15 moles of ethylene oxide and/or propylene oxide is selected preferably from those of the group comprising the ethoxylation products of monohydric alcohols bearing an aromatic six-membered ring substituent. Ethoxylation products of benzyl alcohol and phenoxy ethanol are particularly preferred. The ethoxylation product preferably has 2 to 10 ethylene oxide and/or propylene oxide units, particularly 2.5 to 8 ethylene oxide and/or propylene oxide units. The degrees of alkoxylation mentioned refer in each case to the sum of the ethylene oxide and/or propylene oxide units. Pure ethoxylation products are preferred. Examples thereof include an ethoxylation product of phenoxy ethanol with on average 4 moles of ethylene oxide or an ethoxylation product of benzyl alcohol with on average 5 moles of ethylene oxide.

It is often sufficient for practical purposes for the paint stripper to comprise substantially the components listed. Accordingly, the invention in one particular aspect relates to a paint stripper comprising

a) 40 wt. % to 80 wt. % of water,

b) 10 wt. % to 40 wt. % of organic alcohol,

c) 5 wt. % to 25 wt. % of source of alkali,

d) 1 wt. % to 25 wt. % of ethoxylation and/or propoxylation product of an alcohol bearing an aromatic cyclic substituent, with 2 to 15 moles of ethylene oxide and/or propylene oxide, and

e) 1 wt. % to 15 wt. % of further active or auxiliary substances, the quantity proportions adding up to 100 wt. %.

Generally, further active or auxiliary substances suitable for the purposes of the present invention include e) solubilisers, thickeners, wetting agents and corrosion inhibitors. Examples thereof include carboxylic acids having 6 to 11 carbon atoms which are neutralised preferably with alkanolamines, for example, with monoethanolamine. A preferred example of such a carboxylic acid is isononanoic acid. These carboxylic acids together with the alkanolamines may act as solubilisers. At the same time, they have a corrosion-inhibiting effect on steel surfaces.

The agents described above are concentrates which are diluted for use with water in a ratio of concentrate water of 1:9 to 1:1, preferably 1:4 to 1:2. The correspondingly diluted use solutions also form a subject matter of the present invention.

In a second aspect, the invention relates to a process for stripping lacquer from components made of metal, particularly steel, wherein the components are brought into contact with a paint stripper described above diluted with water as paint stripping solution (use solution) for a period sufficient for complete paint stripping. The contact times are preferably in the range from 10 to 600 minutes, particularly in the range from 20 to 400 minutes. The paint stripping solution preferably has a temperature in the range from 20° C. to 100° C,, particularly in the range from 40° C. to 95° C. Depending on the temperature and active substance concentration, paint stripping times of one hour and below are possible.

Due to the addition according to the invention of alkoxylation products of alcohols with aromatic cyclic substituents, the paint stripping time is reduced compared with paint stripping agents that do not contain this addition. This reduces the production cycles. Conversely, it is conceivable to retain the previous paint stripping times but to lower the active substance concentration. More particularly, the concentration of alcohols having a saturated, unsaturated or aromatic homo- or heterocyclic cyclic substituent may be reduced. This entails a cost saving and, in addition, facilitates the waste water treatment.

The basis of the present invention is, therefore, the observation that an addition of the named alkoxylation products of alcohols with aromatic cyclic substituents markedly improves the paint stripping effect. The invention relates, therefore, in its most general aspect, to the use of ethoxylation and/or propoxylation products of an alcohol bearing an aromatic cyclic substituent, with 2 to 15 moles of ethylene oxide and/or propylene oxide, as an additive in aqueous alkaline paint strippers. The explanations given above under the other aspects of the invention apply to particularly preferred ethoxylation and/or propoxylation products. For all aspects of the present invention, these ethoxylation and/or propoxylation products are used preferably in concentrations in the range from 1 wt. % to 10 wt. %, particularly in the range from 3 wt. % to 7 wt. %.

### EXAMPLES

Lacquered specimen parts made of steel which had been coated with a powder coating based on polyester with a layer thickness of 90 μm to 100 μm were used to test the paint stripping effect. The parts were immersed without movement in the paint stripper which had a temperature of 90° C.

The following comparison mixtures V1, V2 and V3 and mixtures according to the invention B1 and B2 were used for the tests. The composition is given below in wt. %. KOH was used as a 50% aqueous solution. The Tables contain the solids proportion of KOH, whilst the water proportion was classed with the water content. The mixtures are concentrates which were diluted for use with water in a ratio of concentrate:water of 1:9 to 1:1, preferably 1:4 to 1:2.

V1 (comparison)

| | |
|---|---|
| deionized water | 55 |
| Triethylene glycol | 20 |
| Phenoxy ethanol | 5 |
| KOH | 15 |
| n-Octanol × 4 moles ethylene oxide | 5 |

V2 (comparison)

| | |
|---|---|
| Deionized water | 52 |
| Triethylene glycol | 20 |
| Phenoxy ethanol | 5 |
| KOH | 15 |
| Isononanoic acid | 2 |
| Monoethanolamine | 1 |
| Furfuryl alcohol × 5 moles ethylene | 5 |
| oxide | |

V3 (comparison)

| | |
|---|---|
| Deionized water | 46 |
| Triethylene glycol | 20 |
| Phenoxy ethanol | 5 |
| KOH | 15 |
| Isononanoic acid | 6 |
| Monoethanolamine | 3 |
| Phenoxy ethanol × 29 moles ethylene | 5 |
| oxide | |

B1 (according to the invention)

| | |
|---|---|
| Deionized water | 52 |
| Triethylene glycol | 20 |
| Phenoxy ethanol | 5 |
| KOH | 15 |
| Isononanoic acid | 2 |
| Monoethanolamine | 1 |
| Phenoxy ethanol × 4 moles ethylene | 5 |
| oxide | |

B2 (according to the invention)

| | |
|---|---|
| Deionized water | 52 |
| Triethylene glycol | 20 |
| Phenoxy ethanol | 5 |
| KOH | 15 |
| Isononanoic acid | 2 |
| Monoethanolamine | 1 |
| Benzyl alcohol × 5 moles ethylene | 5 |
| oxide | |

Table: Test results. Paint stripping effect in % of the lacquered surface as a function of the paint stripping time. The paint strippers were diluted with water in a ratio of 1:3. Four Material samples were stripped in each case. The Table reproduces the spread of the results obtained.

Paint stripping effect after

| Paint | 10 | 20 | 30 | 40 |
|---|---|---|---|---|
| stripper | minutes | minutes | minutes | minutes |
| V1 | 0 | 10 | 10-50 | 95 |
| V2 | 0 | 0 | 0 | 0 |
| V3 | 0 | 0 | 0 | 0 |
| B1 | 5-10 | 50-90 | 95-98 | |
| B2 | 5-10 | 50-90 | 95-98 | |

What is claimed is:

1. Aqueous alkaline paint stripper which contains water, one or more organic alcohols and sources of alkali, characterised in that it contains, in addition, at least one ethoxylation and/or propoxylation product of an alcohol bearing an aromatic cyclic substituent, with 2 to 15 moles of ethylene oxide and/or propylene oxide.

2. Paint stripper according to claim 1, characterised in that it contains
a) 40 wt. % to 80 wt. % of water,
b) 10 wt. % to 40 wt. % of organic alcohol,
c) 5 wt. % to 25 wt. % of source of alkali,
d) 1 wt. % to 25 wt. % of ethoxylation and/or propoxylation product of an alcohol bearing an aromatic cyclic substituent, with 2 to 15 moles of ethylene oxide and/or propylene oxide, and if desired
e) further active or auxiliary substances, the quantity proportions adding up to 100 wt. %.

3. Paint stripper according to claim 2, characterised in that the organic alcohol b) present is a mixture of b1) di- or triethylene glycol with b2) one or more alcohols bearing a saturated, unsaturated or aromatic home- or heterocyclic cyclic substituent, in a weight ratio of b1) to b2) of 1:0.1 to 1:1.

4. Paint stripper according to one or more of claims 1 to 3, characterised in that the ethoxylation and/or propoxylation product of an alcohol bearing an aromatic cyclic substituent with 2 to 15 moles of ethylene oxide and/or propylene oxide is selected from ethoxylation products of monohydric alcohols bearing an aromatic six-membered ring substituent.

5. Paint stripper according to one or more of claims 1 to 4, characterised in that the ethoxylation and/or propoxylation product of an alcohol bearing an aromatic cyclic substituent contains 2 to 10 ethylene oxide and/or propylene oxide units.

6. Paint stripper according to one or more of claims 2 to 5, characterised in that it comprises
a) 40 wt. % to 80 wt. % of water,
b) 10 wt. % to 40 wt. % of organic alcohol,
c) 5 wt. % to 25 wt. % of source of alkali,
d) 1 wt. % to 25 wt. % of ethoxylation and/or propoxylation product of an alcohol bearing an aromatic cyclic substituent with 2 to 15 moles of ethylene oxide and/or propylene oxide, and
e) 1 wt. % to 15 wt. % of further active or auxiliary substances, the quantity proportions adding up to 100 wt. %.

7. Aqueous use solution for stripping lacquer from components made of metal, which may be obtained by diluting a paint stripper according to one or more of claims 1 to 6 with water in a ratio of paint stripper:water of 1:9 to 1:1, preferably 1:4 to 1:2.

8. A process for stripping lacquer from components made of metal, characterised in that the components are brought into contact with a use solution according to claim 7 which has a temperature in the range from 20° C. to 100° C., preferably in the range from 50° C. to 95° C.

9. The use of ethoxylation and/or propoxylation products of an alcohol bearing an aromatic cyclic substituent with 2 to 15 moles of ethylene oxide and/or propylene oxide as an additive in aqueous alkaline paint strippers.
